(19) United States
(12) Patent Application Publication
(10) Pub. No.: US 2013/0148833 A1
(43) Pub. Date: Jun. 13, 2013

(54) ELECTRONIC APPARATUS

(71) Applicants: Natsumi Endo, Kanagawa (JP); Isao Ohba, Tokyo (JP); Naoto Ito, Tokyo (JP)

(72) Inventors: Natsumi Endo, Kanagawa (JP); Isao Ohba, Tokyo (JP); Naoto Ito, Tokyo (JP)

(21) Appl. No.: 13/661,253

(22) Filed: Oct. 26, 2012

(30) Foreign Application Priority Data
Dec. 12, 2011 (JP) 2011-271569

(51) Int. Cl. H04R 1/02

(52) U.S. Cl. 381/332

(57) ABSTRACT

An electronic apparatus includes: a case configured to house an electronic component that generates heat therein; an air circulation unit provided in the case and that circulates air between outside of the electronic apparatus and the electronic component; a speaker provided around the air circulation unit and that outputs sound; a circulation control unit provided in a part of the air circulation unit and that controls circulation of air between the outside and the electronic component; and a connector that connects with a cradle.

### CROSS REFERENCE TO RELATED APPLICATION(S)

The present disclosure relates to the subject matters contained in Japanese Patent Application No. 2011-271569 filed on Dec. 12, 2011, which are incorporated herein by reference in its entirety.

### FIELD

One or more embodiments of the present invention relate to an electronic apparatus.

### BACKGROUND

In recent years, as an electronic apparatus such as a portable electronic apparatus (for example, a thin type terminal) is miniaturized, the installation density of electronic components has become increased.

Further, heat generated from the electronic components in the electronic apparatus has also increased.

In addition, as the heat generated from the electronic components increases and the electronic components are more densely installed, an internal temperature of the electronic apparatus increases, and an inappropriate influence is exerted on the operation of the electronic apparatus.

As a result, to suppress an increase of internal temperature of the electronic apparatus is required.

### BRIEF DESCRIPTION OF THE DRAWINGS

A general configuration that implements the various features of the invention will be described with reference to the drawings. The drawings and the associated descriptions are provided to illustrate embodiments of the invention and should not limit the scope of the invention.

FIG. 1 is a view illustrating an electronic apparatus according to an exemplary embodiment.

FIG. 2 is a block diagram illustrating a configuration of the electronic apparatus according to the exemplary embodiment.

FIGS. 3A and 3B are views illustrating the electronic apparatus and a cradle according to the exemplary embodiment.

FIGS. 4A and 4B are views illustrating an air circulation unit and a circulation control unit that are formed in the electronic apparatus according to the exemplary embodiment.

FIG. 5 is a view illustrating one example of the air circulation unit in the electronic apparatus according to the exemplary embodiment.

FIG. 6 is a view illustrating another example of the air circulation unit in the electronic apparatus according to the exemplary embodiment.

FIG. 7 is a view illustrating an example in which a temperature sensor is provided in the electronic apparatus according to the exemplary embodiment.

FIGS. 8A to 8D are views illustrating electronic apparatuses according to another exemplary embodiments.

FIGS. 9A to 9D are views illustrating electronic apparatuses according to another exemplary embodiments.

FIGS. 10A to 10C are views illustrating electronic apparatuses according to another exemplary embodiments.

FIGS. 11A and 11B are views illustrating configuration examples of the air circulation unit in the electronic apparatus according to the exemplary embodiments.

### DETAILED DESCRIPTION OF THE EMBODIMENTS

Hereinafter, exemplary embodiments will be described with reference to the accompanying drawings.

In the exemplary embodiment, as described below, an electronic apparatus 31 houses an electronic component (CPU 101) that generates heat inside a case thereof.

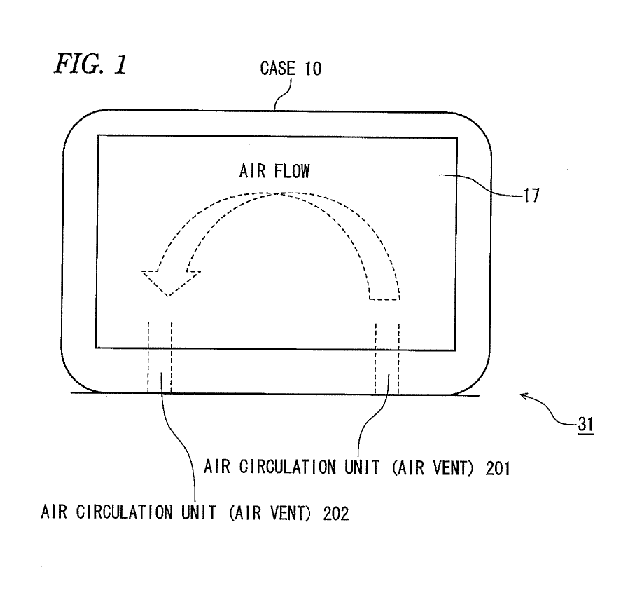

FIG. 1 is a view illustrating an electronic apparatus according to an exemplary embodiment.

Herein, as one example of the electronic apparatus 31, a tablet type PC which is a portable terminal will be described.

The electronic apparatus according to the exemplary embodiment is not limited thereto and may also be applied to a personal computer (PC) or a cellular phone, a smart phone, and portable electronic apparatuses.

As shown in FIG. 1, in the exemplary embodiment, the case 10 of the electronic apparatus 31 includes an air circulation unit (for example, an air circulation unit (air vent) 201 and an air circulation unit (air vent) 202) that enables air to circulate between an outside of the electronic apparatus 31 (a cradle 32) and the electronic component (CPU 101).

Air which flows in/out through the air circulation unit (for example, air circulation unit (air vent) 201 and air circulation unit (air vent) 202) circulates within the case of the electronic apparatus 31 to suppress the increase of the temperature in the electronic apparatus by heat generated from the housed electronic component (CPU 101).

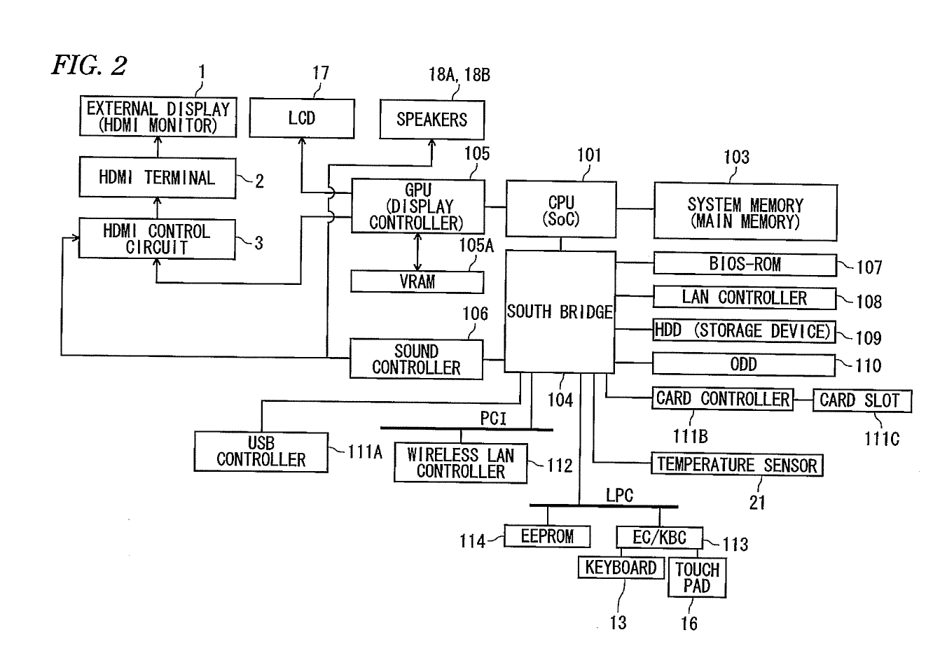

FIG. 2 is a block diagram illustrating the configuration of the electronic apparatus according to the exemplary embodiment.

The electronic apparatus 31 includes, for example, a central processing unit (CPU) 101, a system memory (main memory) 103, a south bridge 104, a graphics processing unit (GPU) 105, a video random access memory (VRAM) 105A, a sound controller 106, a basic input/output system read only memory (BIOS-ROM) 107, a local area network (LAN) controller 108, a hard disk drive (HDD) (storage device) 109, an optical disc drive (ODD) 110, a USB controller 111A, a card controller 111B, a card slot 111C, a wireless LAN controller 112, an embedded controller/keyboard controller (EC/KBC) 113, and an electrically erasable programmable ROM (EEPROM) 114, as shown in FIG. 2.

The CPU (SOC) 101 is a processor that controls the operations of the respective components in the electronic apparatus 31. The CPU (SOC) 101 is constituted by, for example, an SoC.

Herein, the SoC will be described. The SoC is an abbreviation of system-on-a-chip. The SoC is a design technique of an integrated circuit of integrating a required function (system) on one semiconductor chip.

For example, the SoC generally indicates mixing a dedicated functional circuit specialized to a predetermined device in a micro controller.

The CPU (SOC) 101 concentratively uses power and thus has a comparatively large heat dissipation amount and easily generates heat.

The CPU (SCO) 101 executes the BIOS stored in the BIOS-ROM 107. The BIOS is a program for controlling hardware. A memory controller access-controlling the system memory (main memory) 103 is also incorporated in the CPU (SOC) 101. For example, the CPU (SOC) 101 has even a function to execute communication with the GPU 105 through a serial bus of a PCI EXPRESS standard.

The GPU 105 is a display controller controlling an LCD 17 used as a display monitor of the electronic apparatus 31.

A display signal generated by the GPU 105 is transmitted to the LCD 17. The GPU 105 may transmit a digital image signal to an external display 1 through an HDMI control circuit 3 and an HDMI terminal 2.

The HDMI terminal 2 is a connection terminal for the aforementioned external display. The HDMI terminal 2 may transmit an uncompressed digital image signal and digital audio signal to the external display 1 such as a television through one cable. The HDMI control circuit 3 is an interface for transmitting the digital image signal to the external display 1 called as an HDMI monitor through the HDMI terminal 2.

The south bridge 104 controls each device on a peripheral component interconnect (PCI) bus and on a low pin count (LPC) bus. An integrated drive electronics (IDE) controller for controlling the HDD 109 and the ODD 110 is incorporated in the south bridge 104.

The south bridge 104 also has a function to communicate with the sound controller 106.

The sound controller 106 is a sound source device and outputs audio data to be reproduced to speakers (18a, 18b) or the HDMI control circuit 3. The LAN controller 108 is a wired communication device that executes wired communication of, for example, an IEEE 802.3 standard, while the wireless LAN controller 112 is a wireless communication device that executes wireless communication of, for example, an IEEE 802.11g standard. The USB controller 111A executes communication with an external apparatus corresponding to, for example, a USB 2.0 standard.

For example, the USB controller 111A is used to receive an image data file stored in a digital camera. The card controller 111B executes writing/reading data to/from a memory card such as an SD card to be inserted into a card slot provided in a computer (notebook PC) body 11.

The EC/KBC 113 is a one-chip microcomputer in which an embedded controller for power management and a keyboard controller for a keyboard 13 and a touch pad 16 are integrated. The EC/KBC 113 has a function to power ON/OFF the electronic apparatus 31 according to the operation of a power button 14 by a user.

For example, the CPU (SOC) 101 executes a program recorded in the system memory (main memory) 103 or the HDD 109 to perform a display control in the embodiment.

In the exemplary embodiment, an OS is an abbreviation of an operating system.

For example, the OS is software that provides an input/output function called keyboard input or screen output or a basic function commonly used from many application software, such as management of a disk or a memory and manages an entire computer system. Herein, the OS is stored in, for example, the HDD 109.

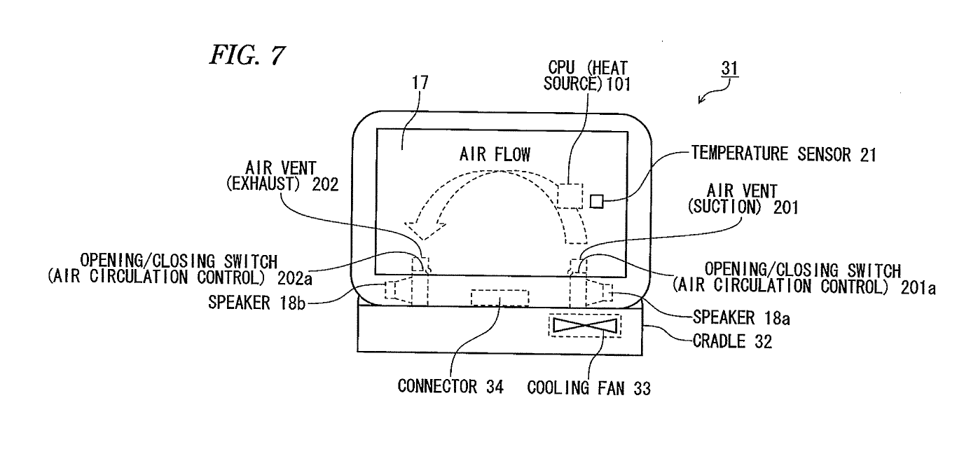

Herein, a temperature sensor 21 described in FIG. 7 is provided.

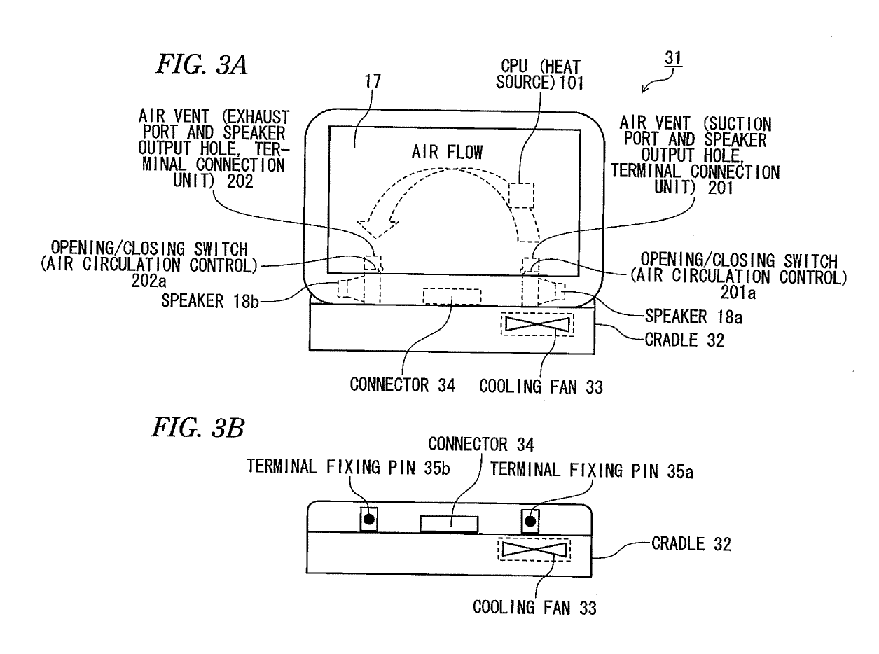

FIGS. 3A and 3B are views illustrating the electronic apparatus and a cradle according to the exemplary embodiment.

Herein, the cradle will be described.

The cradle is, for example, a stand type extension device connected to the electronic apparatus (portable information apparatus). For example, an electronic apparatus body is mounted on the cradle such that the electronic apparatus body and the cradle are mechanically and electrically connected to each other.

With this configuration, the electronic apparatus may transmit/receive the data or file, or charge the electronic apparatus through the cradle.

There are cradles that have a USB port to connect a peripheral device such as a keyboard or a modem to the electronic apparatus.

In the exemplary embodiment, as shown in FIG. 3A, the electronic apparatus 31 has a case to house the electronic component (CPU 101) that generates heat therein.

A part of the air circulation unit (the air vent 201 and the air vent 202) is provided in the case to circulate air between the outside and the electronic component.

Herein, the air circulation unit includes the air vent 201, the air vent 202, and an air circulation path (air flow) within the case.

In the exemplary embodiment, the electronic apparatus 31 includes speakers (speaker 18a and speaker 18b) capable of outputting sound.

The speakers (speaker 18a and speaker 18b) are provided in parts of the air circulation unit (air vent 201 and air vent 202) so as to output sound.

In the exemplary embodiment, a circulation control unit (an opening/closing switch (air circulation control) 201a and an opening/closing switch (air circulation control) 202a) capable of controlling the circulation of air between the outside and the electronic component (CPU 101) is provided in the part of the air circulation unit (air vent 201 and air vent 202).

In the exemplary embodiment, the electronic apparatus 31 is mounted on the cradle 32 to be mechanically and electrically connected.

A connector 34 is used for, for example, the connection of the cradle 32 and the electronic apparatus 31.

The cradle 32 has a cooling fan 33 that blows air to the electronic apparatus 31 through the part of the air circulation unit (herein, air vent 201) to cool, for example, the electronic component (CPU 101).

The blowing from the cradle 32 to the electronic apparatus 31 is performed, for example, while the electronic apparatus 31 is mounted on the cradle 32 such that the electronic apparatus 31 and the cradle 32 are connected to each other, as described above.

FIG. 3B is a view illustrating the configuration of the cradle 32.

As described above, the cradle 32 includes the cooling fan 33 for cooling the electronic component (CPU 101) and the connector 34 for connecting with the electronic apparatus 31.

The connector 34 is used for, for example, the connection of the cradle 32 and the electronic apparatus 31.

The cradle 32 has the cooling fan 33 that blows air to the electronic apparatus 31 through the part of the air circulation unit (herein, air vent 201) to cool, for example, the electronic component (CPU 101).

The blowing from the cradle 32 to the electronic apparatus 31 is performed, for example, while the electronic apparatus 31 is mounted on the cradle 32 such that the electronic apparatus 31 and the cradle 32 are connected to each other, as described above.

The cradle 32 has pins (a terminal fixing pin 35a and a terminal fixing pin 35b) fixing the electronic apparatus 31 when the cradle 32 connects with the electronic apparatus 31.

For example, as described above, while the electronic apparatus 31 is mounted on the cradle 32 to be mechanically and electrically connected, the fixing pins (terminal fixing pin 35a and terminal fixing pin 35b) engage with the circulation control unit (opening/closing switch (air circulation control) 201a and opening/closing switch (air circulation control) 202a) to operate to open the circulation control unit (opening/closing switch (air circulation control) 201a and opening/closing switch (air circulation control) 202a).

For example, the circulation control unit (opening/closing switch (air circulation control) 201a and opening/closing switch (air circulation control) 202a) may be configured to be closed when sound is outputted from the speaker (speaker 18a and speaker 18b).

With this configuration, sound having good quality may be outputted by preventing the sound outputted from the speaker (speaker 18a and speaker 18b) from being attenuated.

The circulation control unit (opening/closing switch (air circulation control) 201a and opening/closing switch (air circulation control) 202a) may effectively perform the air circulation by performing an operation of opening the air circulation unit when a part of the electronic apparatus 31 contacts a part of the cradle 32.

That is, in the exemplary embodiment, the electronic apparatus 31 includes the CPU (heat source) 101 that generates heat therein.

As described above, the electronic apparatus 31 includes the speakers (speaker 18a and speaker 18b) capable of outputting sound, the circulation control unit (opening/closing switch (air circulation control) 201a and opening/closing switch (air circulation control) 202a), the cradle 32, and the connector 34 used to supply information or power.

The cradle 32 includes the pins (terminal fixing pin 35a and terminal fixing pin 35b) fixing the electronic apparatus 31, the connector 34, and the cooling fan 33.

The part of the air circulation unit (air vent 201 and air vent 202) serves as a suction port at one side and an exhaust port at the other side when the electronic apparatus 31 is connected with the cradle 32 as described above.

The cradle 32 receives the air discharged from the electronic apparatus 31 and receives heat from the air.

The cradle 32 includes a cooling member (for example, a heat sink) (not shown) to discharge the heat received from the discharged air to the outside of the cradle 32.

The heat sink is a component that is attached to mechanical and electrical components generating heat so as to decrease temperatures thereof by radiation of heat. The heat sink is called as a heat radiator or a plate-shaped heat sink is called as a heat radiating plate. As the heat sink, metal such as, for example, aluminum or copper which easily conducts heat, is used.

The cradle 32 may be configured to have a high thermal capacity.

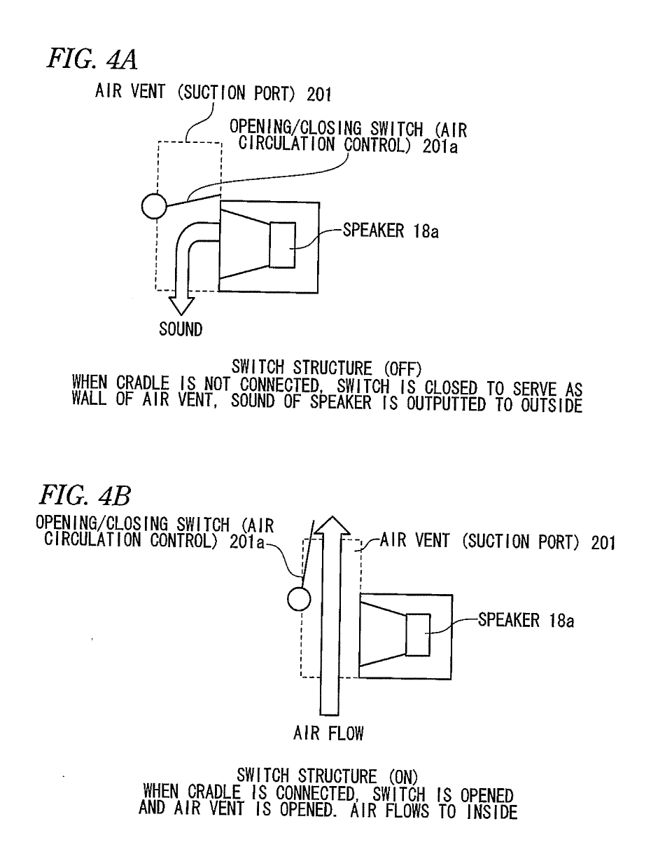

FIGS. 4A and 4B are views illustrating the air circulation unit and the circulation control unit which are formed in the electronic apparatus according to the exemplary embodiment.

Herein, a part of the air circulation unit (air vent 201) and the circulation control unit (opening/closing switch 201a) are illustrated.

The speaker 18a is configured to output sound toward the part of the air circulation unit (vent hole 201).

FIG. 4A illustrates a state where the circulation control unit (opening/closing switch 201a) is turned OFF.

For example, herein, the cradle 32 is not connected to the electronic apparatus 31 and when the cradle 32 is not connected with the electronic apparatus 31, the opening/closing switch (air circulation control) 201a is closed.

The opening/closing switch (air circulation control) 201a is closed to serve as a wall of the part of the air circulation unit (air vent 201), such that the sound outputted from the speaker 18a is outputted to the outside of the electronic apparatus 31.

FIG. 4B illustrates a state where the circulation control unit (opening/closing switch 201a) is turned ON.

For example, herein, the cradle 32 is connected to the electronic apparatus 31. In addition, when the cradle 32 is connected with the electronic apparatus 31, the opening/closing switch (air circulation control) 201a is opened.

Alternatively, when the cradle 32 is connected with the electronic apparatus 31, the opening/closing switch (air circulation control) 201a may be configured to be opened to transport air into the electronic apparatus 31, by wind pressure of the air delivered from the cooling fan 33 of the cradle 32.

The opening/closing switch (air circulation control) 201a is opened, such that the part of the air circulation unit (air vent 201) is opened and the air vent is opened.

For example, the air delivered from the cooling fan 33 of the cradle 32 is introduced into the electronic apparatus 31 to be used for cooling heat generated from the electronic component (CPU 101), as shown in FIG. 4B.

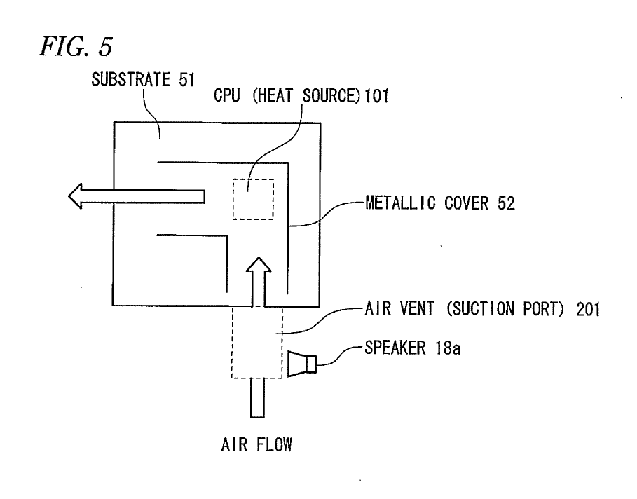

FIG. 5 is a diagram illustrating one example of the air circulation unit in the electronic apparatus according to the exemplary embodiment.

Herein, the electronic component (CPU 101) that generates heat is mounted on a substrate 51. A metallic cover 52 having, for example, a tube shape is formed to cover the electronic component (CPU 101).

Herein, the air outputted from the cradle 32 by blowing is sent toward the electronic component (CPU 101) through the air circulation unit (air vent (suction port) 201).

The metallic cover 52 guides the air blown from the cradle 32 to the electronic component (CPU 101) to cool the electronic component (CPU 101).

That is, the air circulation unit is provided within the case of the electronic apparatus 31 to circulate air between the outside and the electronic component.

Although not particularly shown, the air used for cooling the electronic component (CPU 101) flows toward the cradle 32 through the other air circulation unit 202.

In the exemplary embodiment, the speaker 18a is provided around a part 202 of the air circulation unit to output sound.

That is, in the exemplary embodiment, the metallic cover 52 is provided to surround the heat source (electronic component (CPU 101)) on the substrate 51 as shown in FIG. 5.

The metallic cover 52 guides the air to flow through the air circulation unit (suction port 201 and exhaust port 202).

With this configuration, the air sent from the air circulation unit (suction port 201) flows through the air circulation unit provided by the metallic cover 52 and passes in the vicinity of the heat source (electronic component (CPU 101)) and thereafter, is discharged toward the air circulation unit (exhaust port 202).

That is, the air is guided by the metallic cover 52 to cool the heat source (electronic component (CPU 101)).

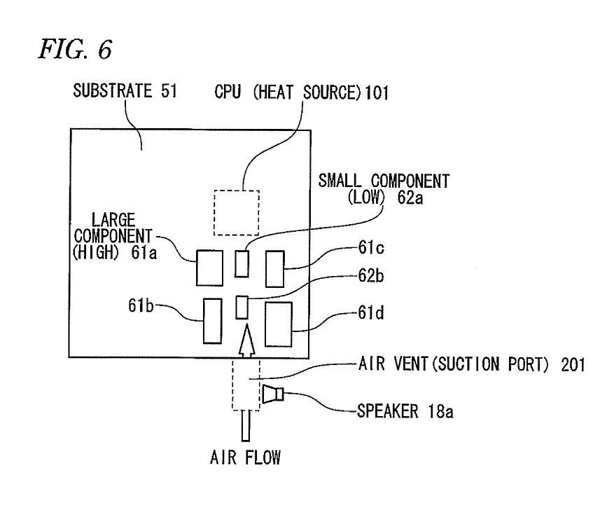

FIG. 6 is a view illustrating another example of the air circulation unit in the electronic apparatus according to the exemplary embodiment.

Herein, the electronic component (CPU 101) that generates heat is mounted on the substrate 51 similarly as above. Herein, a guide unit (the combination of a second electronic component and a third electronic component) that guides the air flow is formed so as to acquire the same cooling effect as above by combining the second electronic components (electronic components 61a, 61b, 61c, and 61d) having a relatively large size and a large height and the third electronic components (electronic components 62a, and 62b) having different shapes from shapes of the second electronic components (relatively smaller and lower than the second electronic components), which are different from the electronic component (CPU 101).

The air outputted from the cradle 32 by blowing is sent toward the electronic component (CPU 101) through the air circulation unit (air vent (suction port) 201), similarly as above.

The guide unit (the combination of the second electronic component and the third electronic component) guides the air blown from the cradle 32 to the electronic component (CPU 101) to cool the electronic component (CPU 101).

Although not particularly shown, the air used for cooling the electronic component (CPU 101) flows toward the cradle 32 through the other air circulation unit 202.

Even in the exemplary embodiment, the speaker 18a is provided around a part 202 of the air circulation unit to output sound.

That is, in the exemplary embodiment, the guide unit (the combination of the second electronic component and the third electronic component) is provided to surround the heat source (electronic component (CPU 101)) on the substrate 51, as shown in FIG. 6.

Herein, the guide unit (the combination of the second electronic component and the third electronic component) configures a part of the air circulation unit.

That is, in the exemplary embodiment, the second electronic component having a relatively large size and height is disposed outside a path that connects the air circulation unit (suction port 201) and the heat source (electronic component (CPU 101)) and the third electronic component having a smaller size and height than the second electronic component is disposed in the air circulation path.

In this case, for example, as shown in FIG. 6, the second electronic component and the third electronic component may be mounted so that short sides thereof face the heat source (electronic component (CPU 101)) (alternatively, so that long sides of the second electronic component and the third electronic component do not face the heat source (electronic component (CPU 101))).

With this configuration, as described above, the guide unit (the combination of the second electronic component and the third electronic component) is formed within the case of the electronic apparatus 31.

With this configuration, air (wind) is efficiently blown to the heat source (electronic component (CPU 101)) to improve the cooling effect.

FIG. 7 is a view illustrating an example in which a temperature sensor is provided in the electronic apparatus according to the exemplary embodiment.

Herein, as compared with the electronic apparatus 31 shown in FIG. 3A, for example, a temperature sensor 21 is further provided.

Even in the exemplary embodiment, the electronic apparatus 31 includes a case similarly as above to house the electronic component (CPU 101) generating heat therein.

The part of the air circulation unit (air vent 201 and air vent 202) is provided in the case to circulate air between the outside and the electronic component.

Herein, the air circulation unit includes the air vent 201, the air vent 202, and the air circulation path (air flow) within the case.

In the exemplary embodiment, the electronic apparatus 31 includes the speakers (speaker 18a and speaker 18b) capable of outputting sound.

The speakers (speaker 18a and speaker 18b) is provided in the part of the air circulation unit (air vent 201 and air vent 202) to output sound.

Even in the exemplary embodiment, the circulation control unit (opening/closing switch (air circulation control) 201a and opening/closing switch (air circulation control) 202a) capable of controlling the circulation of air between the outside and the electronic component (CPU 101) is provided in the part of the air circulation unit (air vent 201 and air vent 202).

Even in the exemplary embodiment, the electronic apparatus 31 is mounted on the cradle 32 to be mechanically and electrically connected.

The connector 34 is used for, for example, the connection of the cradle 32 and the electronic apparatus 31.

The cradle 32 has the cooling fan 33 that blows air to the electronic apparatus 31 through a part of the air circulation unit (herein, air vent 201) to cool the electronic component (CPU 101).

The blowing from the cradle 32 to the electronic apparatus 31 is performed, for example, while the electronic apparatus 31 is mounted on the cradle 32 such that the electronic apparatus 31 and the cradle 32 are connected to each other as described above.

In the exemplary embodiment, as shown in FIG. 7, the temperature sensor 21 is provided around the heat source (electronic component (CPU 101)) to detect temperature information around the heat source (electronic component (CPU 101)).

For example, as described above, when the electronic apparatus 31 and the cradle 32 are connected to each other, the temperature information detected in the temperature sensor 21 is sent to the cradle 32 through the connector 34.

The cradle 32 receives the temperature information and controls the operation of the cooling fan 33 using the received temperature information.

For example, when a temperature around the heat source (electronic component (CPU 101)) is detected as a high temperature higher than a predetermined value by the received temperature information, a control unit (not shown) of the cradle 32 turns ON the cooling fan 33 to perform blowing with respect to the electronic apparatus 31.

Similarly, when the temperature around the heat source (electronic component (CPU 101)) is detected as a low temperature lower than the predetermined value by the received temperature information, the control unit (not shown) of the cradle 32 turns OFF the cooling fan 33 to stop blowing with respect to the electronic apparatus 31.

Therefore, the cooling fan 33 may operate as necessary, and as a result, power consumption may be reduced or the life-span of the cradle 32 or the cooling fan 33 may be increased.

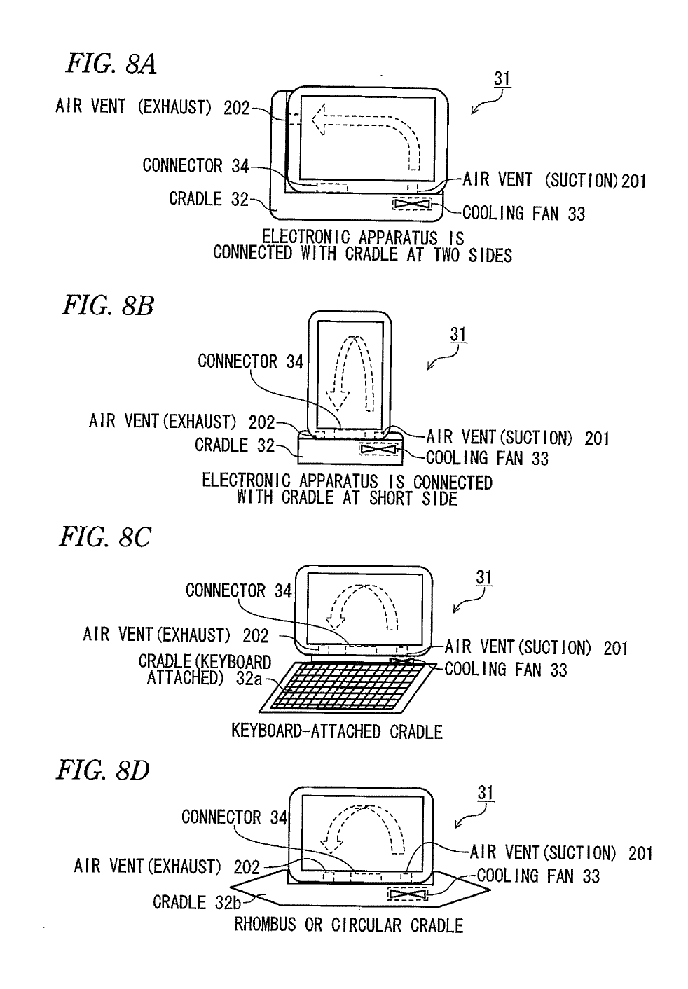

FIGS. 8A to 8D are views illustrating electronic apparatuses according to another exemplary embodiments.

FIG. 8A illustrates an example in which an electronic apparatus 31 is configured such that a cradle 32 is in contact with two sides of the electronic apparatus 31.

Herein, a part of an air circulation unit (air vent (suction) 201) having a substantially hollow shape is provided at a long side portion of the electronic apparatus 31 having a flat plate (slate) shape to send air from a cooling fan 33 of the cradle 32.

The air circulates along the air circulation unit within the case of the electronic apparatus 31 to be guided to flow around an electronic component (CPU 101) that generates heat, similarly as above.

For example, a connector 34 is also provided at the long side portion of the electronic apparatus 31.

A part of the air circulation unit (air vent (exhaust) 202) having the substantially hollow shape is provided at a short side portion of the electronic apparatus 31 to thereby discharge the air that flows around the electronic component (CPU 101) that generates heat and circulates in the air circulation unit within the case of the electronic apparatus 31.

The cradle 32 receives the air discharged from the electronic apparatus 31 and receives heat from the air, similarly as above.

The cradle 32 may have a cooling member (heat sink) (not shown) and may discharge the heat received from the discharged air to the outside of the cradle 32 or may have a high thermal capacity.

FIG. 8B illustrates an example in which the electronic apparatus 31 is configured such that the cradle 32 is in contact with the short side of the electronic apparatus 31.

Herein, the part of the air circulation unit (air vent (suction) 201) is provided at the short side portion of the electronic apparatus 31 to send air from the cooling fan 33 of the cradle 32.

The air circulates in the air circulation unit within the case of the electronic apparatus 31 to be guided to flow around the electronic component (CPU 101) that generates heat, similarly as above.

For example, the connector 34 is also provided at the short side portion of the electronic apparatus 31.

A part of the air circulation unit (air vent (exhaust) 202) having the substantially hollow shape is provided at the short side portion of the electronic apparatus 31 to thereby discharge the air that flows around the electronic component (CPU 101) that generates heat and circulates in the air circulation unit within the case of the electronic apparatus 31.

FIG. 8C illustrates an example (a keyboard attached cradle 32a) in which the cradle 32 has a keyboard.

Herein, a part of the air circulation unit (air vent (suction) 201) is provided at the long side portion of the electronic apparatus 31 to send air from the cooling fan 33 of the cradle 32, similarly as above.

The air circulates in the air circulation unit within the case of the electronic apparatus 31 to be guided to flow around the electronic component (CPU 101) that generates heat, similarly as above.

For example, the connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) generating heat and circulates in the air circulation unit within the case of the electronic apparatus 31.

FIG. 8D illustrates an example in which the cradle 32 is configured to have a rhombus shape (alternatively, a circular shape) (a rhombus or circular cradle 32b).

Herein, a part of the air circulation unit (air vent (suction) 201) is provided at the long side portion of the electronic apparatus 31 to send air from the cooling fan 33 of the cradle 32.

The air circulates in the air circulation unit within the case of the electronic apparatus 31 to be guided to flow around the electronic component (CPU 101) generating heat, similarly as above.

The connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) that generates heat and circulates in the air circulation unit within the case of the electronic apparatus 31.

In the exemplary embodiment, various modifications in the shape or type of the cradle 32 may be made.

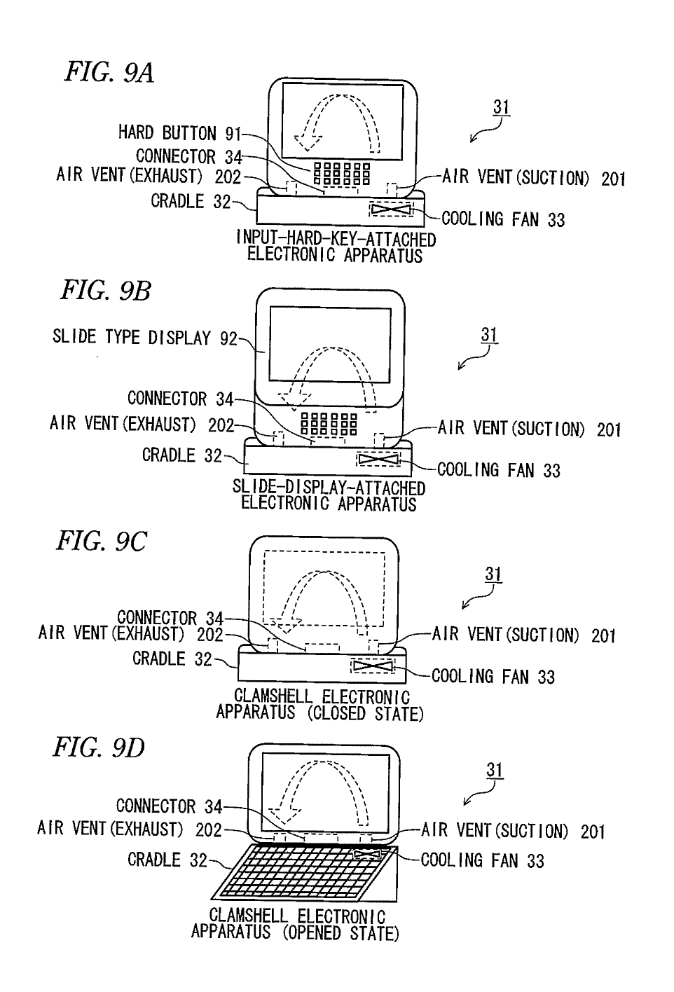

FIGS. 9A to 9D are views illustrating electronic apparatuses according to another exemplary embodiments.

FIG. 9A illustrates an example in which the electronic apparatus 31 is configured to have input hard keys (hard button 91) (input-hard-keys-attached electronic apparatus).

Herein, a part of the air circulation unit (air vent (suction) 201) is provided at the long side portion of the electronic apparatus 31 to send air from the cooling fan 33 of the cradle 32, similarly as above.

The air circulates in the air circulation unit within the case of the electronic apparatus 31 to be guided to flow around the electronic component (CPU 101) that generates heat, similarly as above.

The connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) that generates heat and circulates in the air circulation unit within the case of the electronic apparatus 31.

The cradle 32 receives the air discharged from the electronic apparatus 31 and receives heat from the air, similarly as above.

The cradle 32 may have a cooling member (heat sink) (not shown) and may discharge the heat received from the discharged air to the outside of the cradle 32 or may have a high thermal capacity.

FIG. 9B illustrates an example in which the electronic apparatus 31 is configured to have a slide type display (a slide type display 92) (slide-display-attached electronic apparatus).

Even herein, a part of the air circulation unit (air vent (suction) 201) is provided at the long side portion of the electronic apparatus 31 to send air from the cooling fan 33 of the cradle 32, similarly as above.

The air circulates in the air circulation unit within the case of the electronic apparatus 31 to be guided to flow around the electronic component (CPU 101) that generates heat, similarly as above.

For example, the connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) heat and circulates in the air circulation unit within the case of the electronic apparatus 31.

FIG. 9C illustrates an example in which the electronic apparatus 31 is configured to have a clamshell. Herein, the clamshell is in a closed state.

The clamshell is, for example, a shape in which the electronic apparatus (mobile terminal) may be folded by a hinge.

For example, in a cellular phone, the clamshell is called even a folding type or a flip type.

Herein, a part of the an air circulation unit (air vent (suction) 201) is provided at the long side portion of the electronic apparatus 31 to send air from the cooling fan 33 of the cradle 32, similarly as above.

The air circulates in the air circulation unit within the case of the electronic apparatus 31 to be guided to flow around the electronic component (CPU 101) that generates heat, similarly as above.

For example, the connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) generating heat and circulates in the air circulation unit within the case of the electronic apparatus 31.

In FIG. 9D, the electronic apparatus 31 has the clamshell and the clamshell is in an opened state.

Herein, a part of the air circulation unit (air vent (suction) 201) is provided at the long side portion of the electronic apparatus 31 to send air from the cooling fan 33 of the cradle 32, similarly as above.

The air circulates in the air circulation unit within the case of the electronic apparatus 31 to be guided to flow around the electronic component (CPU 101) generating heat, similarly as above.

For example, the connector 34 is also provided at the long side portion of the electronic apparatus 31.

A part of the air circulation unit (air vent (exhaust) 202) having the substantially hollow shape is provided at the long side portion of the electronic apparatus 31 to thereby discharge the air that flows around the electronic component (CPU 101) generating heat and circulates in the air circulation unit within the case of the electronic apparatus 31.

In the exemplary embodiment, as such, the electronic apparatus 31 is not limited to a tablet type PC and may also be applied to, for example, a personal computer (PC) or a cellular phone, a smart phone, and a portable electronic device.

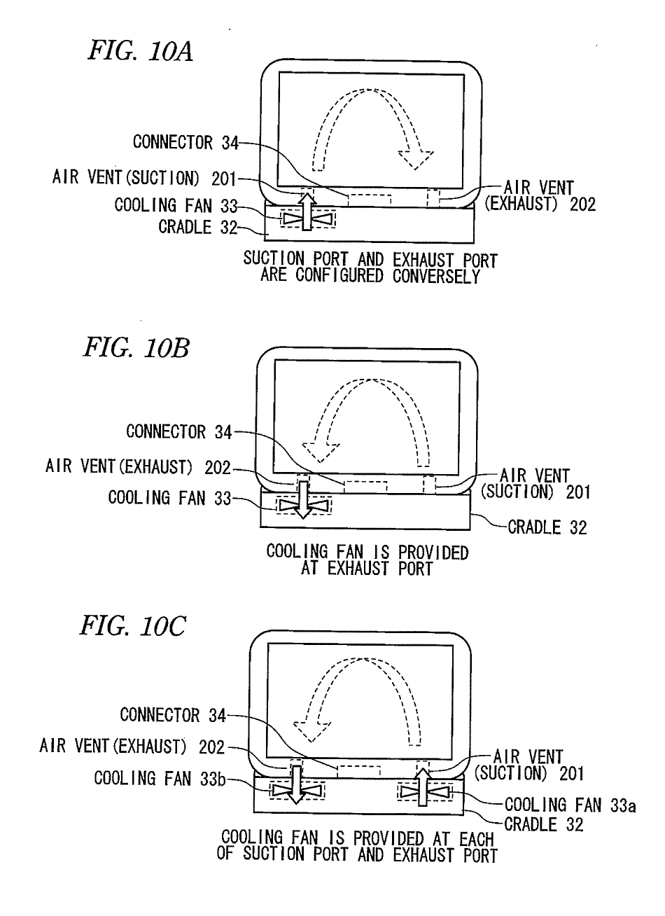

FIGS. 10A to 10C are views illustrating electronic apparatuses according to another exemplary embodiments.

FIG. 10A illustrates an example in which the suction port and the exhaust port are configured conversely as compared with the configuration of FIG. 3A.

That is, herein, as shown in FIG. 10A, the position of a part of the air circulation unit (air vent 201 and air vent 202) provided in the case of the electronic apparatus 31 is opposite to that of FIG. 3A.

The cooling fan 33 provided in the cradle 32 is provided so that the position of the cooling fan 33 corresponds to the position of a part (air vent (suction) 201) of the air circulation unit.

As in FIG. 3A, the electronic apparatus 31 has the case to house the electronic component (CPU 101) that generates heat therein.

The part of the air circulation unit (air vent 201 and air vent 202) is provided in the case to circulate air between the outside and the electronic component.

Even herein, the air circulation unit includes the air vent 201, the air vent 202, and the air circulation path (air flow) within the case.

Although not particularly shown, even in the exemplary embodiment, the electronic apparatus 31 includes the speakers (speaker 18a and speaker 18b) capable of outputting sound, similarly as above.

The speakers (speaker 18a and speaker 18b) are provided in the parts of the air circulation unit (air vent 201 and air vent 202) to output sound.

In the exemplary embodiment, the circulation control unit (opening/closing switch (air circulation control) 201a and opening/closing switch (air circulation control) 202a) capable of controlling the circulation of air between the outside and the electronic component (CPU 101) is provided in the part of the air circulation unit (air vent 201 and air vent 202).

In the exemplary embodiment, the electronic apparatus 31 is mounted on the cradle 32 to be mechanically and electrically connected.

The connector 34 is used for, for example, the connection of the cradle 32 and the electronic apparatus 31.

FIG. 10B illustrates an example in which the cooling fan 33 is provided to correspond to the exhaust port (a part of the air circulation unit (air vent 202)) as compared with FIG. 3A.

Herein, as shown in FIG. 10B, the cooling fan 33 operates to suction the air discharged from the exhaust port (a part of the air circulation unit (air vent 202)).

FIG. 10C illustrates an example in which two cooling fans (cooling fan 33a and cooling fan 33b) are provided in the cradle 32 to perform suctioning or blowing with respect to the two air vents (a part of the air circulation unit (air vent (exhaust) 202 and air vent (suction) 201), respectively.

That is, herein, the cooling fan 33b is provided to correspond to the exhaust port (a part of the air circulation unit (air vent 202)) to perform exhaustion from a part of the air circulation unit (air vent (exhaust) 202) using the cooling fan 33b.

Further, the cooling fan 33a is provided to correspond to the suction port (a part of the air circulation unit (air vent 201)) to send air to the suction port (the part of the air circulation unit (air vent 201)) using the cooling fan 33b.

That is, in the exemplary embodiment, as such, a blowing or exhaustion direction is not particularly limited and may be appropriately changed.

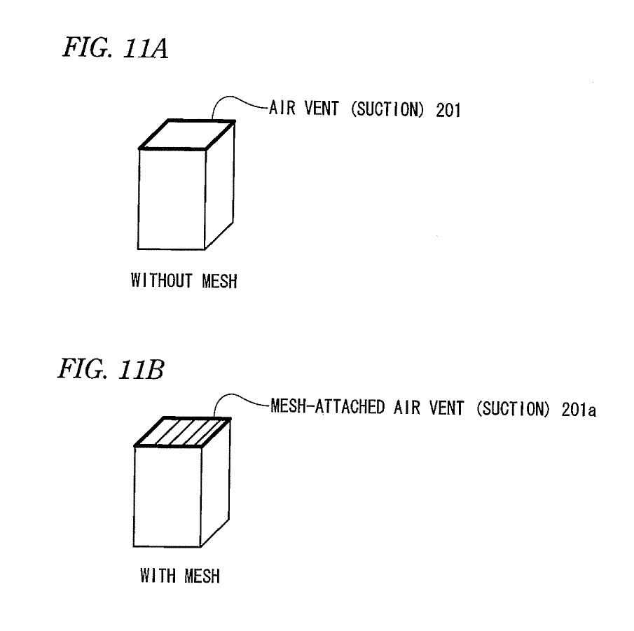

FIGS. 11A and 11B are views illustrating configuration examples of the air circulation unit in the electronic apparatus according to the exemplary embodiment.

Herein, the suction port (a part of the air circulation unit (air vent 201)) will be described as an example.

In FIG. 11A, the suction port (the part of the air circulation unit (air vent 201)) is configured by a substantially tube shaped hollow and in particular, the suction port does not have a mesh.

In FIG. 11B, the suction port (a part of the air circulation unit (air vent 201)) is configured by the substantially tube shaped hollow and in particular, the suction port has a mesh.

Herein, the mesh means a mesh of a net and is provided to, for example, prevent dust from getting into the electronic apparatus 31.

By the above configuration, in the exemplary embodiment, an internal temperature of the electronic apparatus can be prevented from being increased.

The exemplary embodiments are not limited to a technology itself and in an implementation step, components can be variously modified and concretized within the scope without departing from the spirit thereof.

Various inventions can be achieved by appropriately combining a plurality of components disclosed in the exemplary embodiments.

For example, some components may be deleted from all components described in the exemplary embodiments. Components according to other exemplary embodiments may be appropriately combined with each other.

What is claimed is:

1. An electronic apparatus, comprising:
a case configured to house an electronic component that generates heat therein;
an air circulation unit provided in the case and configured to circulate air between outside of the electronic apparatus and the electronic component;
a speaker provided around the air circulation unit and configured to output sound;
a circulation control unit provided in a part of the air circulation unit and configured to control circulation of air between the outside and the electronic component; and
a connector configured to connect with a cradle.

2. The electronic apparatus of claim 1, wherein the circulation control unit controls the circulation of air by substantially opening and closing the air circulation unit.

3. The electronic apparatus of claim 1, wherein the air circulation unit circulates air discharged from the cradle.

4. The electronic apparatus of claim 1, wherein the air circulation unit includes an air receiving portion configured to receive the air discharged from the cradle and an air discharging portion configured to discharge the air that has circulated in the case toward the cradle.

5. The electronic apparatus of claim 2, wherein the circulation control unit is configured to be closed when the sound is outputted from the speaker.

6. The electronic apparatus of claim 1, wherein the circulation control unit opens the air circulation unit when a part of the electronic apparatus contacts a part of the cradle.

7. The electronic apparatus of claim 1, wherein the cradle comprises a fan used for delivering or suctioning air.

8. The electronic apparatus of claim 1, wherein the circulation control unit comprises a guide unit configured to guide air flow in the case.

9. The electronic apparatus of claim 8, wherein the guide unit guides the air flow by combining a second electronic component different from the electronic component and a third electronic component whose shape is different from a shape of the second electronic component.

10. The electronic apparatus of claim 8, wherein the air circulation unit comprises a suction portion used to suction air into the electronic apparatus and an exhaust portion used to exhaust air from the electronic apparatus.
